(19) United States
(12) Patent Application Publication
(10) Pub. No.: US 2008/0238785 A1
(43) Pub. Date: Oct. 2, 2008

(54) Antenna and frequency modulation method thereof

(75) Inventors: Li-Sen Chen, Kwei-Shan Hsiang (TW); Wen-Tsung Hsiao, Shan Hsiang (TW)

Correspondence Address: Joe McKinney Muncy, PO Box 1364, Fairfax, VA, 22038-1364, US

(73) Assignee: SPEED TECH CORP.

(21) Appl. No.: 11/727,579

(22) Filed: Mar. 27, 2007

(51) Int. Cl. H01Q 1/36

(52) U.S. Cl. 343/700 R

(57) ABSTRACT

An antenna and a method for modulating an operating frequency band of the antenna are provided. The present antenna includes a plastic body comprising at least a hallow portion, and a metal element disposed inside the plastic body, wherein the metal element is flat and comprises a planar radiation portion and two extending portions, wherein a shape and a size of the hallow portion are adjustable. The operating frequency band of the antenna is modulated according to a shape and a size of the hallow portion.

### BACKGROUND

1. Field of Invention

The present invention relates to an antenna. More particularly, the present invention relates to an antenna of which an operating frequency band is able to be modulated, and a related modulation method thereof.

2. Description of Related Art

With advances in the communication technology and increases of the communication applications, the communication products are becoming diversified, and the requirement of the function of the communication products by consumers is increasing. Therefore, there are more and more communication products with different designs and functions brought to the market. Among all the communication products, the ones with wireless communication abilities are the most popular. The maturity of integrated circuits further helps to shrink the size of communication products.

The designs of antennas verify for radiating and receiving different categories of signals required by different communication products. The rhombic antenna, the turnstile antenna, the triangle microstrip antenna and the planar inverted-F antenna are some of the examples. In the planar inverted-F antenna in the prior art, a small metal element is installed on a ground plane as a radiation body, and a shorting line stretches from an edge of the radiation body, i.e., the metal element, is coupled to the ground plane. The length of the antenna may be reduced from one second of the resonance wave length to one fourth of the resonance wave length, in accordance. Hence the size of the antenna is reduced.

However, it is necessary to adjust the operating frequency band of antenna productions in order to meet the requirement of different communication productions or to compensate the shift of the operating frequency band of the antenna productions due to the housing of the communication productions. In the prior art, the modulation of the operating frequency band of the antenna is achieved by mainly designing and changing a metal element of the antenna. Therefore, it is required for the molds employed for forming the metal element and implementing the following steps, for example, a step for enclosing the metal element, to change in consequence due to the change of the shape of the metal element.

For the foregoing reasons, there is a need for an antenna capable of modulating the operating frequency band without changing the appearance and shape of the antenna.

### SUMMARY

The present invention is directed to an antenna capable of adjusting an operating frequency band thereof and a related method to meet the requirement of different communication applications.

It is therefore an aspect of the present invention to provide an antenna including a plastic body and a metal element. The plastic body includes at least a hallow portion therein. The metal element is installed inside the plastic body. The metal element is flat and includes a planar radiation portion and two extending portions. The operating frequency band of the antenna is finely modulated according to a shape or a size of the hallow portion.

It is another aspect of the present invention to provide a method for modulating an operating frequency band of an antenna. The method includes providing a metal element, wherein the metal element is flat and comprises a planar radiation portion and two extending portions, forming a plastic body for enclosing the metal element, and forming a hallow portion in the plastic body, wherein an operating frequency band of the antenna is modulated according to a shape and a size of the hallow portion.

In conclusion, the invention introduces an antenna and a related method for modulating an operating frequency band of the antenna, such that the appearance and shape of the antenna remains the same.

These and other features, aspects, and advantages of the present invention will become better understood with reference to the following description, figures, and appended claims.

It is to be understood that both the foregoing general description and the following detailed description are by examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 is a diagram of a metal element utilized in an embodiment of the present invention;

FIG. 2A is a pictorial drawing of an antenna according to a preferred embodiment of the present invention;

FIG. 2B is a pictorial drawing of an antenna according to another preferred embodiment of the present invention;

FIG. 2C is a pictorial drawing of an antenna according to another preferred embodiment of the present invention;

FIG. 2D is a pictorial drawing of an antenna according to another preferred embodiment of the present invention;

FIG. 2E is a pictorial drawing of an antenna according to another preferred embodiment of the present invention;

FIG. 2F is a pictorial drawing of an antenna according to another preferred embodiment of the present invention;

FIG. 2G is a pictorial drawing of an antenna according to another preferred embodiment of the present invention;

FIG. 2H is a pictorial drawing of an antenna according to another preferred embodiment of the present invention;

FIGS. 3A and 3B are plan views of antennas according to embodiments of the present invention; and

FIG. 4 is a chart illustrating experiment data of the operation frequency of an antenna and the return loss according to an embodiment of the present invention.

### DESCRIPTION OF THE PREFERRED EMBODIMENTS

According to the antenna and the related method for modulating the operating frequency band of the antenna introduced by the present invention, a metal element is installed in a plastic body with a hallow portion. The operating frequency band of the antenna is modulated according to the shape and/or the size of the hallow portion to meet the requirement of the application. Reference will now be made in detail to the present preferred embodiments of the invention, examples of which are illustrated in the accompanying drawings. Wherever possible, the same reference numbers are used in the drawings and the description to refer to the same or like parts.

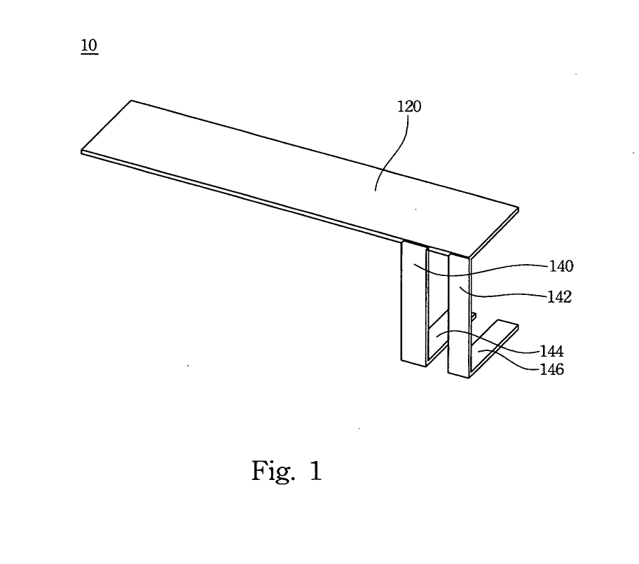

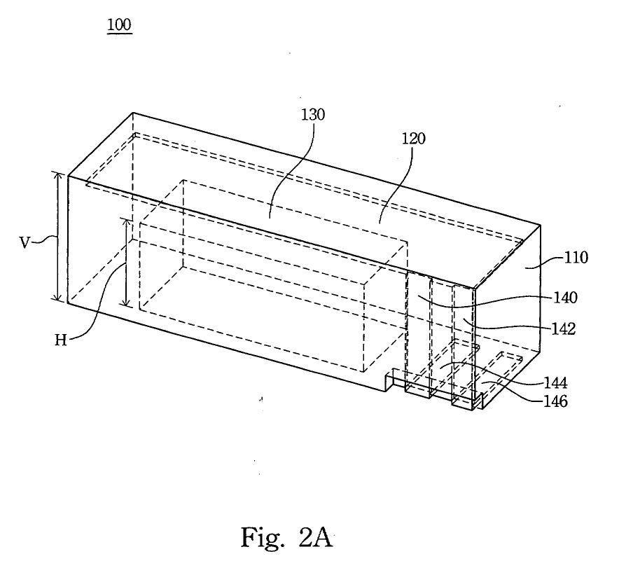

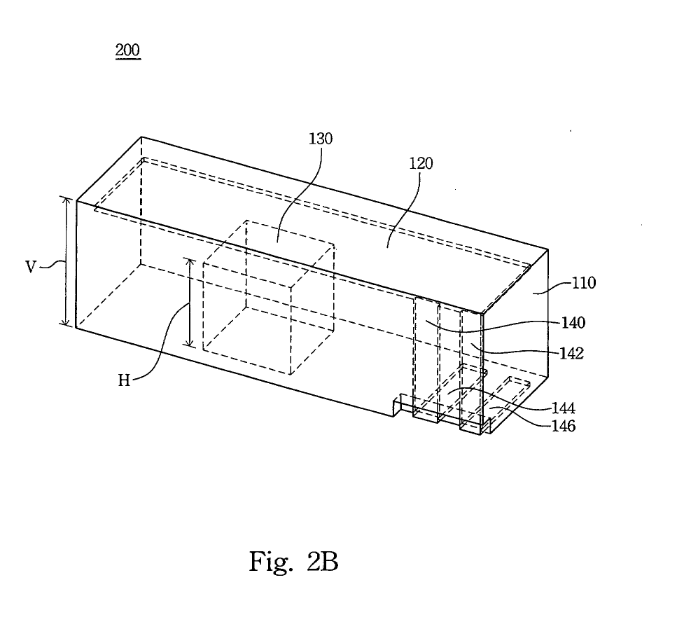

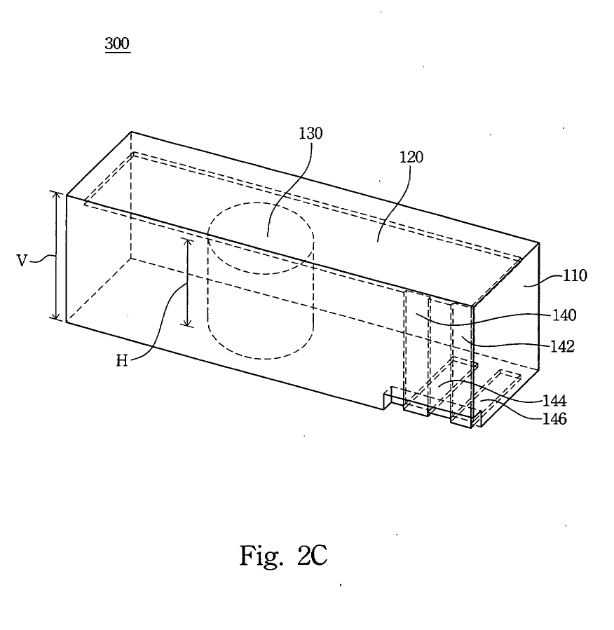

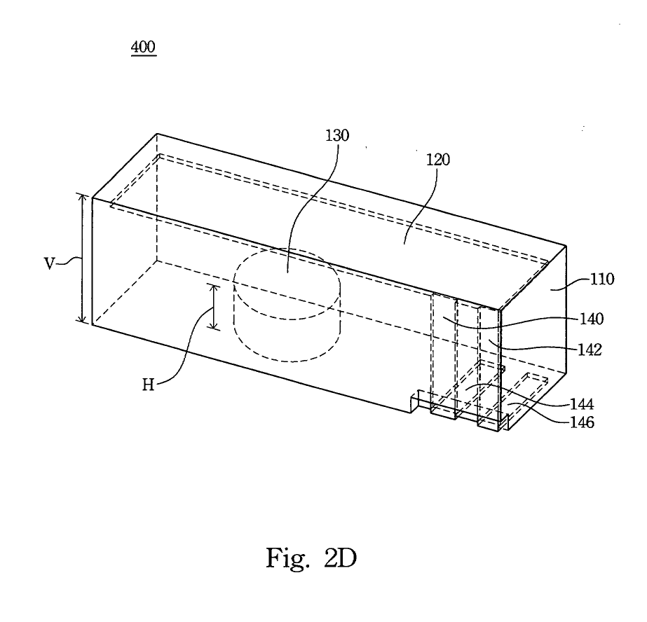

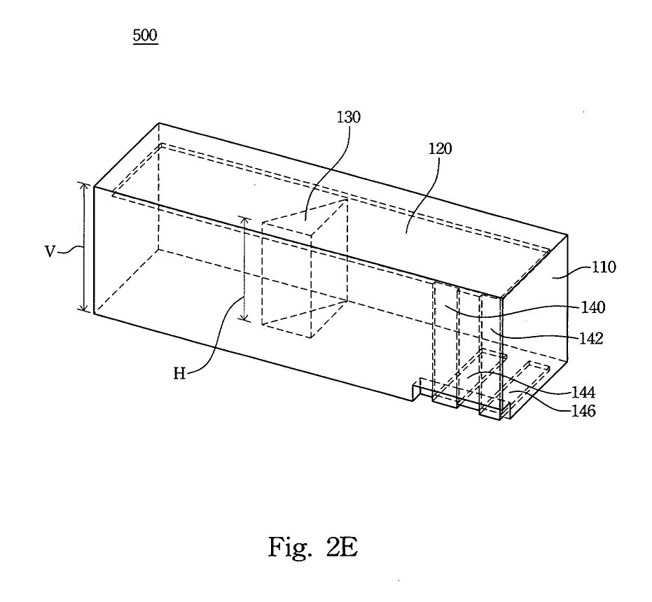

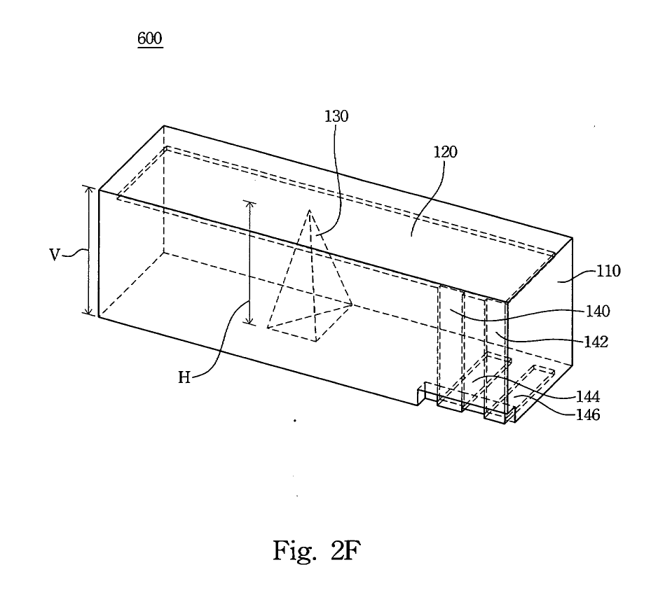

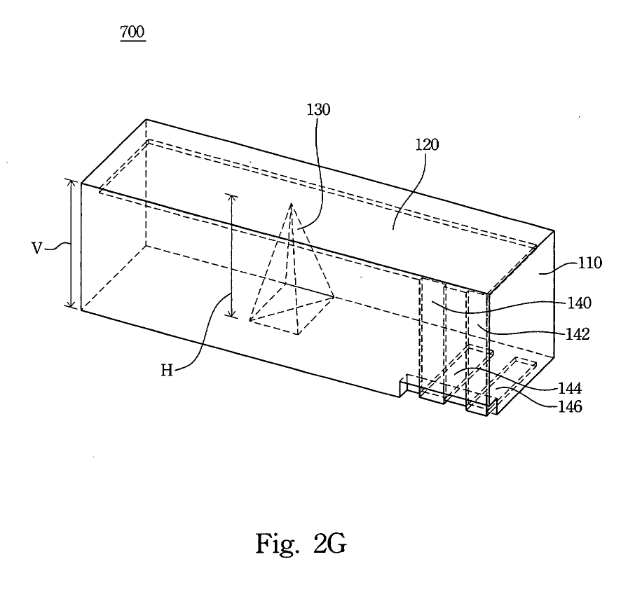

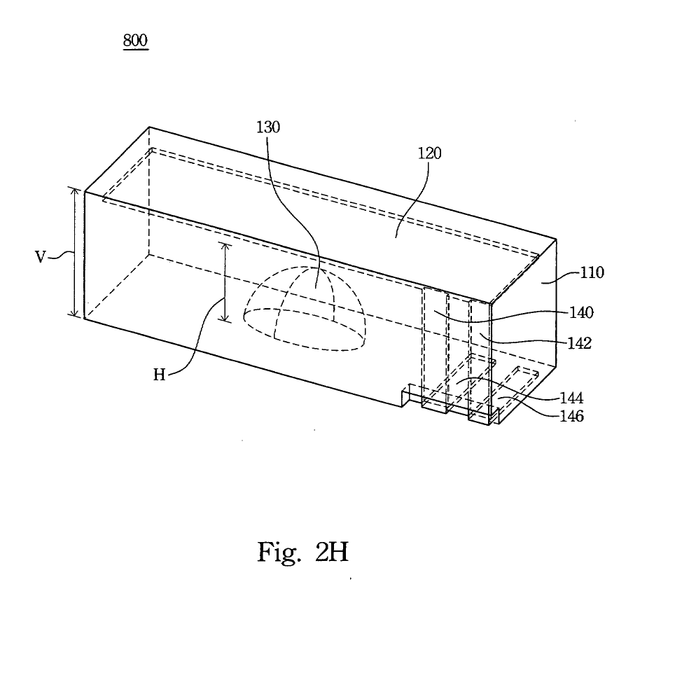

FIG. 1 is a diagram of a metal element utilized in an embodiment of the present invention, and FIG. 2A is a pictorial drawing of an antenna according to a preferred embodiment of the present invention. Referring to FIG. 1 and FIG. 2A, an antenna 100 includes at least a plastic body 110 with a hallow portion 130 inside, and a metal element 10. The plastic body 110 and the hallow portion 130 are geometric solid. A cuboid is only exemplary but not restrictive to the plastic body 110. For example, the plastic body 110 may be varied according to shape of the metal element 10 or the hallow portion 130. The hallow portion 130 may be a cuboid, a cube, a cylinder, an elliptic cylinder, a triangular prism, a trigonal pyramid, a tetragonal pyramid or a hemisphere, etc.

The metal element 10 is flat, including a planar radiation portion 120 and two extending portions 140 and 142. The planar radiation portion 120 and the extending portions 140 and 142 may be substantially perpendicular. The metal element 10 is installed inside the plastic body 110. More specifically, the hallow portion 130 is next to the planar radiation portion 120, and the hallow portion 130 may contact the planar radiation portion 120.

The extending portions 140 and 142 further include a feeding end 144 and a grounding end 146, each of which extending outwardly from the extending portions 140 and 142, separately. It is apparent to those skilled in the art that the feeding end 144 and the grounding end 146 can be interchanged. The feeding end 144 is installed at an end of the extending portion 140 for outputting or receiving signals, while the grounding end 146 is configured at an end of the extending portion 142 for grounding.

FIG. 2B is a pictorial drawing of an antenna 200 according to another preferred embodiment of the present invention. The antenna 200 includes a plastic body 110, including at least a hallow portion 130, and a metal element 10. In the antenna 200 shown in FIG. 2B, the plastic body 110 is a cuboid and the hallow portion 130 is a cube. FIG. 2C is a pictorial drawing of an antenna 300 according to still another preferred embodiment of the present invention. In the antenna 300 shown in FIG. 2C, the plastic body 110 is a cuboid and the hallow portion 130 is a cylinder. FIG. 2D is a pictorial drawing of an antenna 400 according to yet another preferred embodiment of the present invention. In the antenna 400 shown in FIG. 2D, the plastic body 110 is a cuboid and the hallow portion 130 is a cylinder. FIG. 2E is a pictorial drawing of an antenna 500 according to another preferred embodiment of the present invention. In the antenna 500 shown in FIG. 2E, the plastic body 110 is a cuboid and the hallow portion 130 is a triangular prism. FIG. 2F is a pictorial drawing of an antenna 600 according to another preferred embodiment of the present invention. In the antenna 600 shown in FIG. 2F, the plastic body 110 is a cuboid and the hallow portion 130 is a trigonal pyramid. FIG. 2G is a pictorial drawing of an antenna 700 according to another preferred embodiment of the present invention. In the antenna 700 shown in FIG. 2G, the plastic body 110 is a cuboid and the hallow portion 130 is a tetragonal pyramid. FIG. 2H is a pictorial drawing of an antenna 800 according to another preferred embodiment of the present invention. In the antenna 800 shown in FIG. 2H, the plastic body 110 is a cuboid and the hallow portion 130 is a hemisphere.

Referring to FIG. 2A, a present method for modulating an operating frequency band of the antenna 100 may be illustrated therein. The method of the present invention includes providing a metal element 10, forming a plastic body 110 enclosing the metal element 10, and forming a hallow portion 130 inside the plastic body 110. The metal element 10 is flat, including a planar radiation portion 120 and two extending portions 140 and 142. The hallow portion 130 is completely surrounded by the plastic body 110, right next to the planar radiation portion 120, and may contact the planar radiation portion 120. The extending portions 140 and 142 further include a feeding end 144 and a grounding end 146, extending outwardly from the extending portions 140 and 142, separately. The modulation of the operating frequency band of the antenna 100 is according to a shape and a size of the hallow portion 130. The plastic body 110 and the hallow portion 130 are formed geometrically solid. The plastic body 110 is not restricted to a cuboid, but may be varied according to the shape of the metal element 10 or the hallow portion 130. The hallow portion 130 may be a cuboid, a cube, a cylinder, an elliptic cylinder, a triangular prism, a trigonal pyramid, a tetragonal pyramid or a hemisphere, depending on the design and the requirement.

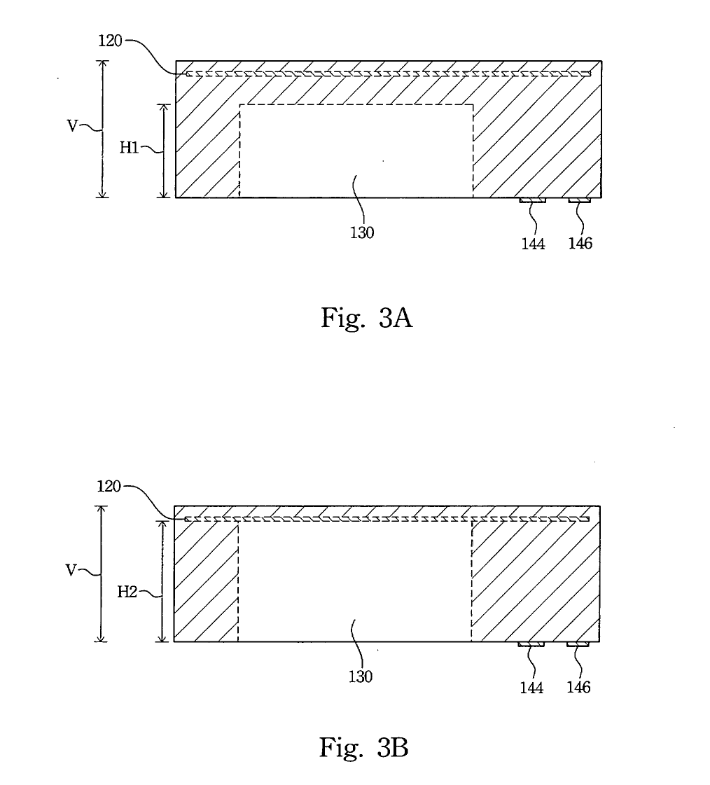

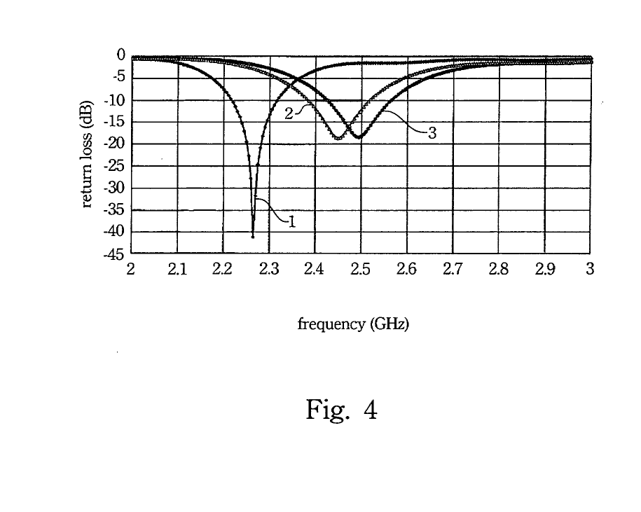

FIGS. 3A and 3B are plan views of antennas of the present invention. The only difference between the antennas illustrated in FIG. 3A and FIG. 3B is the height of the hallow portion 130, which is H1 in FIG. 3A and H2 in FIG. 3B. FIG. 4 is a chart illustrating experiment data of the operation frequency of an antenna and the return loss according to an embodiment of the present invention. The curve 1 in FIG. 4 displays data of an antenna in the prior art, while the curve 2 and the curve 3 display data of the antennas with different heights H1 and H2 of the hallow portion 130 as shown in FIGS. 3A and 3B, respectively. The operating frequency of the curve 1 is 2.27 GHz, the operating frequency of the curve 2 is 2.45 GHz, and the operating frequency of the curve 3 is 2.49 GHz. It is observed in accordance that, in the embodiment of the present invention, the modulation of the operating frequency band of the antenna is related to the height of the hallow portion 130.

In summary, the shift of the operating frequency band of the antenna due media, for example, air and the plastic body, through which the signals are radiated, may be adjusted and modulated by shaping or resizing the hallow portion 130 as described above in order to meet the requirement of the design and the application.

Although the present invention has been described in considerable detail with reference to certain preferred embodiments thereof, other embodiments are possible. Their spirit and scope of the appended claims should not be limited to the description of the preferred embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An antenna comprising:
a plastic body comprising at least a hallow portion; and
a metal element, disposed inside the plastic body, wherein the metal element is flat and comprises a planar radiation portion and two extending portions,
wherein a shape and a size of the hallow portion are adjustable.

2. The antenna of claim 1, wherein the hallow portion is next to the planar radiation portion.

3. The antenna of claim 1, wherein the hallow portion is in contact with the planar radiation portion.

4. The antenna of claim 1, wherein the extending portions further comprise a feeding end and a grounding end, extending outwardly from the extending portions.

5. The antenna of claim 1, wherein the hallow portion is a cuboid, a cube, a cylinder, an elliptic cylinder, a triangular prism, a trigonal pyramid, a tetragonal pyramid or a hemisphere.

6. The antenna of claim 1, wherein the extending portions is perpendicular to the planar radiation portion.

7. A method for modulating an operating frequency band of an antenna, comprising steps of:
providing a metal element, wherein the metal element is flat and comprises a planar radiation portion and two extending portions;
forming a plastic body for enclosing the metal element; and
forming a hallow portion in the plastic body, wherein an operating frequency band is modulated according to a shape and a size of the hallow portion.

8. The method for modulating the operating frequency band of the antenna of claim 7, wherein the hallow portion is next to the planar radiation portion.

9. The method for modulating the operating frequency band of the antenna of claim 7, wherein the hallow portion is in contact with the planar radiation portion.

10. The method for modulating the operating frequency band of the antenna of claim 7, wherein the hallow portion is completely surrounded by the plastic body.

11. The method for modulating the operating frequency band of the antenna of claim 7, wherein the hallow portion is a cuboid, a cube, a cylinder, an elliptic cylinder, a triangular prism, a trigonal pyramid, a tetragonal pyramid or a hemisphere.

12. The method for modulating the operating frequency band of the antenna of claim 7, wherein the extending portions further comprise a feeding end and a grounding end, extending outwardly from the extending portions.
